(19) United States
(12) Patent Application Publication
(10) Pub. No.: US 2026/0238974 A1
(43) Pub. Date: Aug. 13, 2026

(54) Monophonic Audio for True Wireless Earbuds

(71) Applicant: Google LLC, Mountain View, CA (US)

(72) Inventors: Daniel BARROS, Porto (PT); Sunil KUMAR, Cupertino, CA (US)

(21) Appl. No.: 19/149,678

(22) PCT Filed: Jan. 19, 2024
(86) PCT No.: PCT/US2024/012105

§ 371 Date: Jul. 21, 2025

Related U.S. Application Data
(60) Provisional application No. 63/440,047, filed on Jan. 19, 2023.

(51) Int. Cl. H04W 4/80; H04R 1/10; H04W 12/033

(52) U.S. Cl. CPC H04W 4/80; H04R 1/1016; H04R 1/1041; H04W 12/033; H04R 2420/07

(57) ABSTRACT

Various arrangements for using a short-range wireless communication link are presented herein. A session configuration can be performed between a pair of true wireless earbuds and an audio source device in which a single connected isochronous stream (CIS) is established to transmit a monophonic audio stream. After performing the session configuration, the primary earbud can receive an audio packet transmitted on the single CIS addressed. Despite the audio packet being successfully received by the primary earbud, a negative acknowledgement may be transmitted to the audio source device in response to determining that data of the audio packet has not yet been transmitted a predefined number of times.

### CROSS-REFERENCE TO RELATED APPLICATIONS

This application claims the benefit of and priority to U.S. Provisional Application No. 63/440,047, filed on Jan. 19, 2023, and titled “BLUETOOTH COMMUNICATION IMPROVEMENTS.” The content of the foregoing application is herein incorporated by reference in its entirety for all purposes.

### BACKGROUND

Transmitting wireless audio data using a wireless communication protocol, such as Bluetooth Low Energy (LE) Audio, to a pair of true wireless earbuds can involve an audio source device transmitting a first audio packet to a first earbud and then separately transmitting a second audio packet to the second earbud. Even when the audio data is monophonic, meaning the same audio is to be output by each earbud, conventional arrangements require that separate audio packets be transmitted separately to each earbud.

Such an arrangement is not efficient. Separately transmitting the same data to each earbud wastes air-time bandwidth, which could be used for other purposes, such as communication with other wireless devices. Embodiments detailed herein provide improvements by using less air-time bandwidth, other improvements, or both.

### SUMMARY

Various embodiments are described related to a method for using a short-range wireless communication link. In some embodiments, a method for using a short-range wireless communication link is described. The method may comprise performing a session configuration between a pair of true wireless earbuds and an audio source device in which a single connected isochronous stream (CIS) may be established to transmit a monophonic audio stream from the audio source device to the pair of true wireless earbuds. The pair of true wireless earbuds may comprise a primary earbud and a secondary earbud. The method may comprise after performing the session configuration, receiving, by the primary earbud, an audio packet transmitted on the single CIS addressed to only the primary earbud. The method may comprise determining, by the primary earbud, that the audio packet was successfully received by the primary earbud. The method may comprise determining, by the primary earbud, that data of the audio packet has not yet been transmitted a predefined number of times. The method may comprise despite determining that the audio packet was successfully received by the primary earbud, transmitting a negative acknowledgement to the audio source device in response to determining that data of the audio packet has not yet been transmitted a predefined number of times.

Embodiments of such a method may include one or more of the following features: the method may further comprise determining, by the secondary earbud, that the audio packet has not been successfully received. The method may further comprise receiving, by the secondary earbud, a second audio packet transmitted on the single CIS, where the second audio packet may comprise same audio data as the audio packet. The method may further comprise determining, by the secondary earbud, that the second audio packet has been successfully received. The method may further comprise during a connected isochronous group (CIG) interval in which the audio packet was received by the primary earbud, transmitting, by the primary earbud, audio data from the audio packet to the secondary earbud. The method may further comprise receiving, by the secondary earbud, the audio data from the primary earbud. The method may further comprise receiving, by the primary earbud, a second audio packet transmitted on the single CIS, where the second audio packet may comprise same audio data as the audio packet. The method may further comprise determining, by the primary earbud, that data of the second audio packet has been transmitted the predefined number of times. The method may further comprise transmitting an acknowledgement to the audio source device in response to determining that data of the second audio packet has been transmitted the predefined number of times. The secondary earbud may not transmit acknowledgements or negative acknowledgements to the audio source device. The method may further comprise determining, by the primary earbud, a signal strength of a communication link with the secondary earbud. The method may further comprise adjusting, by the primary earbud, the predefined number based at least in part on the signal strength of the communication link with the secondary earbud. The short-range wireless communication link between the primary earbud and the audio source device may be a Bluetooth Low Energy (BLE) communication link. The method may further comprise outputting, by the primary earbud, audio using a first speaker of the primary earbud. The method may further comprise outputting, by the secondary earbud, audio using a second speaker of the secondary earbud. The audio that is output by the primary earbud and the secondary earbud may be the same. Performing the session configuration may comprise receiving and storing, by the secondary earbud, encryption credentials for the primary earbud. The method may further comprise receiving, by the secondary earbud, the audio packet transmitted on the single CIS addressed to only the primary earbud. The method may further comprise decrypting, by the secondary earbud, the audio packet using the encryption credentials.

In some embodiments, a pair of true wireless earbuds is described. The earbuds may comprise a primary earbud, comprising a first speaker, a first processing system, and a first wireless communication interface. The earbuds may comprise a secondary earbud, comprising a second speaker, a second processing system, and a second wireless communication interface. The secondary earbud may not be physically connected with the primary earbud and the primary earbud may be configured to perform a session configuration with an audio source device in which a single connected isochronous stream (CIS) may be established to transmit a monophonic audio stream from the audio source device to the primary earbud. The primary earbud may be configured to after performing the session configuration, receive an audio packet transmitted on the single CIS addressed to only the primary earbud. The primary earbud may be configured to determine that the audio packet was successfully received by the primary earbud. The primary earbud may be configured to determine that data of the audio packet has not yet been transmitted a predefined number of times. The primary earbud may be configured to despite determining that the audio packet was successfully received by the primary earbud, transmit a negative acknowledgement to the audio source device in response to determining that data of the audio packet has not yet been transmitted a predefined number of times.

Embodiments of such a device may include one or more of the following features: the secondary earbud may be configured to determine that the audio packet has not been successfully received. The secondary earbud may be further configured to receive a second audio packet transmitted on the single CIS, where the second audio packet may comprise same audio data as the audio packet. The secondary earbud may be further configured to determine that the second audio packet has been successfully received. The primary earbud may be further configured to during a connected isochronous group (CIG) interval in which the audio packet was received by the primary earbud, transmit audio data from the audio packet to the secondary earbud. The primary earbud may be further configured to receive a second audio packet transmitted on the single CIS, where the second audio packet may comprise same audio data as the audio packet. The primary earbud may be further configured to determine that data of the second audio packet has been transmitted the predefined number of times. The primary earbud may be further configured to transmit an acknowledgement to the audio source device in response to determining that data of the second audio packet has been transmitted the predefined number of times. The secondary earbud does not transmit acknowledgements or negative acknowledgements to the audio source device. The primary earbud may be further configured to determine a signal strength of a communication link with the secondary earbud. The primary earbud may be further configured to adjust the predefined number based at least in part on the signal strength of the communication link with the secondary earbud. The short-range wireless communication link between the primary earbud and the audio source device may be a Bluetooth Low Energy (BLE) communication link. The primary earbud may be configured to output audio using the first speaker. The secondary earbud may be configured to output audio using the second speaker. The audio that is output by the primary earbud and the secondary earbud may be the same. The secondary earbud may be further configured to receive and store encryption credentials for the primary earbud. The secondary earbud may be further configured to receive the audio packet transmitted on the single CIS addressed to only the primary earbud.. The secondary earbud may be further configured to decrypt the audio packet using the encryption credentials.

### BRIEF DESCRIPTION OF THE FIGURES

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of an audio system in which a single CIS link is used to transmit a monophonic audio stream to a pair of true wireless earbuds.

FIG. 2 illustrates an embodiment of a block diagram of an audio system that includes a pair of true wireless earbuds communicating with an audio source.

FIG. 3 illustrates an embodiment of an audio system in which true wireless earbuds communicate with each other in addition to communicating with an audio source.

FIG. 4A illustrates an embodiment of communications between an audio source and earbuds using a single CIS event within a CIG interval using a cross acknowledgement.

FIG. 4B illustrates an embodiment of communications between an audio source and earbuds using a single CIS event within a CIG interval in which a cross acknowledgement is not received.

FIG. 4C illustrates another embodiment of communications between an audio source and earbuds using a single CIS event within a CIG interval using a cross acknowledgement.

FIG. 4D illustrates an embodiment of a method for communicating between an audio source and earbuds using a single CIS within a CIG interval using a cross acknowledgement.

FIG. 5A illustrates an embodiment of communications between an audio source and earbuds using a single joint CIS event within a CIG interval.

FIG. 5B illustrates an embodiment of communications between an audio source and earbuds using a single joint CIS event within a CIG interval in which the second earbud did not receive the transmitted audio packet.

FIG. 5C illustrates an embodiment of communications between an audio source and earbuds using a single joint CIS event within a CIG interval in which the first earbud did not receive the transmitted audio packet.

FIG. 5D illustrates an embodiment of communications between an audio source and earbuds using a single joint CIS event within a CIG interval without relay of audio between earbuds.

FIG. 5E and FIG. 5F illustrate an embodiment of a method for communicating between an audio source and earbuds using a single CIS within a CIG.

### DETAILED DESCRIPTION

Arrangements detailed herein provide improvements for transmitting monophonic (“mono”) audio from an audio source to a pair of true wireless earbuds, from the pair of true wireless earbuds to the audio source, or both. “Mono audio” refers to a single audio channel. In the context of earbuds, the same audio is output by each earbud to the user's ears. Mono audio is commonly used for voice phone calls, but other situations also exist that use mono audio, such as certain music playback and gaming applications. “True wireless earbuds” refer to earbuds that both: 1) receive audio wirelessly from one or more audio sources; and 2) are not in physical communication with each other, such as via a wire that is used for communication and/or power. Therefore, in a pair of true wireless earbuds, each earbud must have its own power supply and wireless communication interface to allow for wireless communication and audio output. As detailed herein, embodiments of earbuds, unless otherwise noted, are directed to true wireless earbuds.

When a communication session is established for mono audio, a single audio stream may be established to the pair of true wireless earbuds. In a Bluetooth LE communication link, a single connected isochronous stream (CIS) can be established to a primary earbud of the pair of true wireless earbuds. From the perspective of the audio source, the mono audio stream is transmitted to only the primary earbud. Various arrangements, as detailed herein, allow for the audio data transmitted via the single CIS to also be obtained by the other earbud. Both earbuds may have the necessary stored encryption credentials and configuration data in order to receive and decrypt the single CIS. In some embodiments, a cross-acknowledgement transmitted directly between the earbuds is used to coordinate whether an audio packet was properly received by both earbuds. In other embodiments, a predefined or variable number of negative acknowledgements (“NAKs”) may be transmitted by the primary earbud to the audio source device, even if the primary earbud properly received the audio packet transmitted on the CIS. By transmitting at least one NAK, even if the packet was successfully received, the likelihood that the second earbud successfully received the audio packet can be increased. In some embodiments, the number of NAKs transmitted is a fixed predefined number, such as two or three. In other embodiments, the number of NAKs can be dynamically varied based on factors such as the quality of a communication link between the earbuds, the ability of each earbud to successfully receive audio packets directly from the audio source, or both.

Such embodiments can greatly improve air-time bandwidth performance. Rather than the audio source having to transmit the same audio data to each earbud of a pair of true wireless earbuds separately, such as using separate CISs in the case of Bluetooth LE, the audio source device only needs a single CIS to send the audio data. From the perspective of the audio source, the audio source is communicating with only one earbud. The earbuds then manage exchange of audio data between each other to the extent necessary in the various detailed embodiments. Using embodiments detailed herein, air-time bandwidth usage can improve by up to 50% by using a single CIS for mono audio rather than separate CISs for each earbud of a pair of true wireless earbuds.

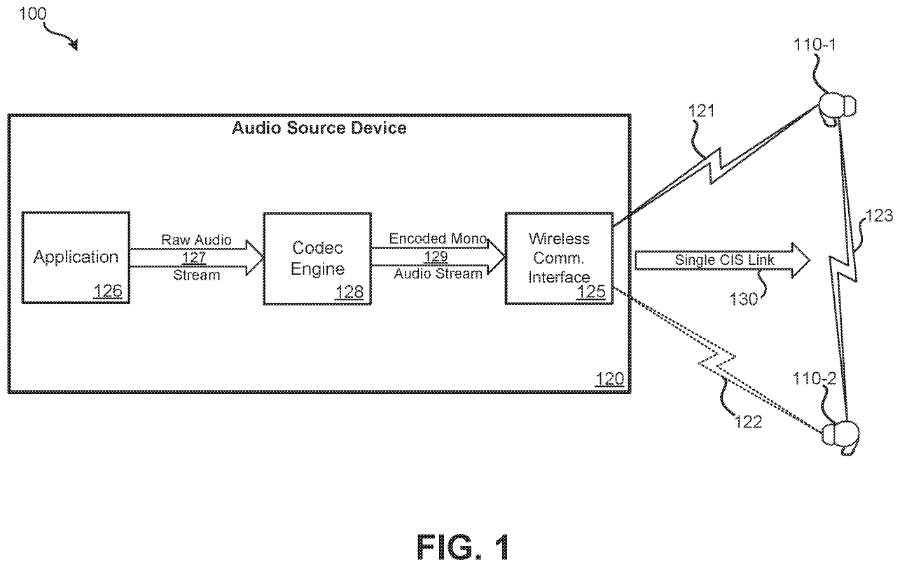

FIG. 1 illustrates an embodiment of an audio system 100 in which a single CIS link is used to transmit a monophonic audio stream to a pair of true wireless earbuds 110 from audio source device 120. Audio system 100 can include: audio source device 120; application 126; codec engine 128; wireless communication interface 125; and true wireless earbuds 110, which include earbud 110-1 and earbud 110-2. In embodiments that use a device-to-device communication protocol other than Bluetooth LE, another form of audio streaming can be used that does not rely on a CIS link.

Audio source device 120 represents a device that can transmit wireless audio to true wireless earbuds 110. Audio source device 120 can be: a smartphone; a cellular phone; an audio player; a gaming device; a laptop or desktop computer; a public announcement system; etc. Audio source device 120 can include various hardware that allows it to execute software, such as application 126. Audio source device 120 can include one or more processors and non-transitory processor-readable mediums on which software, such as application 126, can be stored.

Application 126 represents an application to output raw audio stream 127. Raw audio stream 127 is in the form of mono audio. Application 126 can, for example, be an application used to make voice phone calls (e.g., via a cellular network, via a voice over IP, VoIP, system). Other examples of applications include: gaming applications; music streaming applications; video or audio conferencing applications; voicemail applications; web browser applications; video streaming applications; business applications. Other forms of applications are also possible. Application 126 can also be a software component or module that is incorporated as part of an operating system.

Application 126 outputs raw audio stream 127. Raw audio stream 127 can represent a mono audio stream that has yet to be encoded into the appropriate format for wireless transmission. Raw audio stream 127 may be passed to codec engine 128. Codec engine 128 selects and uses an appropriate codec to encode raw audio stream 127, such as based on raw audio stream 127 being a mono audio stream and the audio to be transmitted using a particular wireless communication protocol, such as Bluetooth LE (e.g., BLE Audio). Codec engine 128 can be implemented in the form of specialized software operating on general-purpose hardware (e.g., a general-purpose processor of audio source device 120) or special-purpose hardware (e.g., a processor with dedicated encoding circuitry). Codec engine 128 can be incorporated as part of wireless communication interface 125 or can exist as a separate software or hardware module. The output of codec engine 128 is encoded mono audio stream 129.

Wireless communication interface 125 (“interface 125”) receives encoded mono audio stream 124 from codec engine 128. In some embodiments, interface 125 is a Bluetooth LE (BLE) communication interface that uses BLE for wireless communication with audio output devices, such as true wireless earbuds 110. In response to having mono audio to be transmitted to true wireless earbuds 110, wireless communication interface 125 can establish a communication session with earbuds 110. Establishing this communication session can include a single CIS 130 for transmitting audio packets from interface 125 to a primary earbud (e.g., earbud 110-1) being established. As part of the communication session being established, earbuds 110 can receive information indicative that a single audio channel is to be transmitted by interface 125. Further, as part of the establishment of the communication session, the secondary earbud (e.g., earbud 110-2) can receive all information necessary in order to successfully receive and decrypt packets transmitted by interface 125 addressed to the primary earbud (e.g., earbud 110-1). Communication path 121 represents the wireless communications between interface 125 and the primary earbud; communication path 122 represents the secondary earbud capturing the wireless communications addressed to the primary earbud.

Not pictured, can be one or more asynchronous connection-oriented links (ACLs). ACLs are used for transmitting control information from interface 125 to earbuds 110 and from earbuds 110 to interface 125. Such control information can refer to data such as commands and, more generally, non-audio packets. A single CIS link 130 on which the mono audio is transmitted is illustrated. In some embodiments, a CIS link from earbuds 110 to interface 125 may additionally be present, such as to transmit audio data received via one or more microphones of earbuds 110.

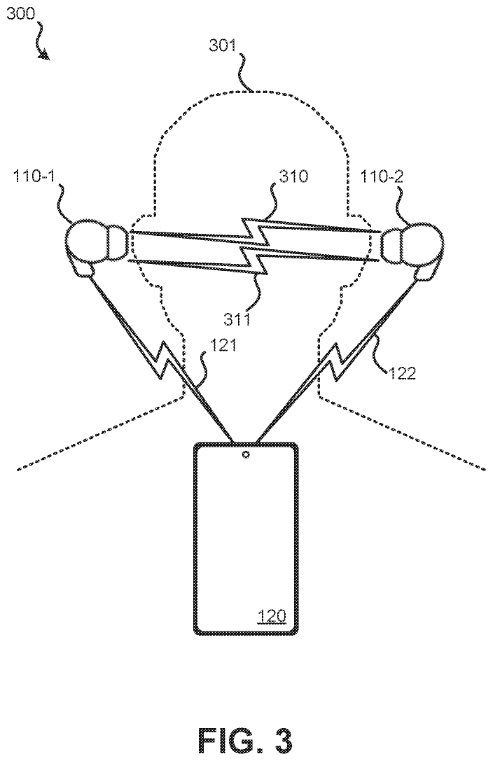

In embodiments detailed herein, direct communication between earbuds 110-1 and 110-2 occurs, as represented by communication path 123. Further detail regarding such communication is provided in relation to FIG. 3. While the focus of FIG. 1 is on mono audio being transmitted from interface 125 to earbuds 110, audio (e.g., mono audio) may additionally or alternatively be transmitted from earbuds 110 to interface 125.

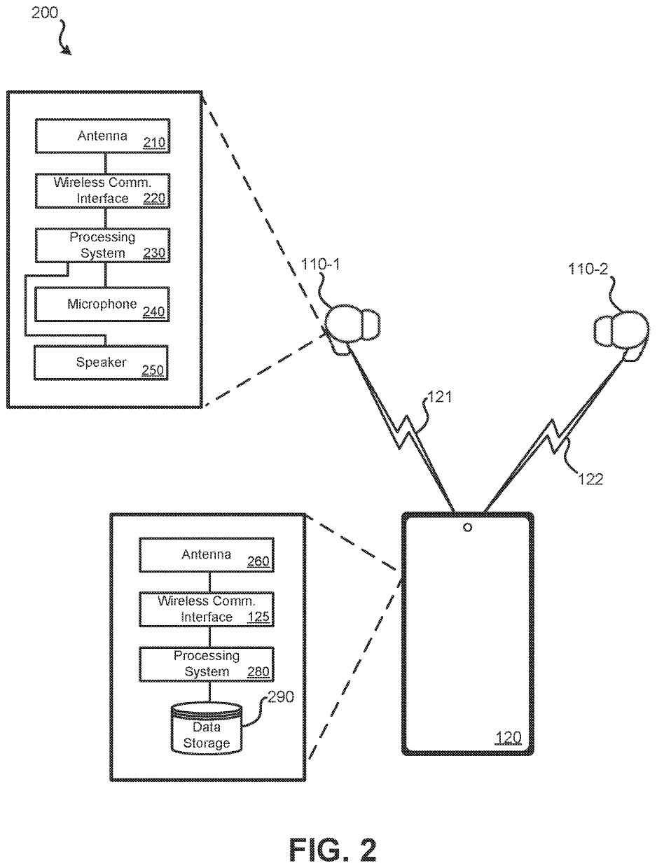

FIG. 2 illustrates an embodiment of a block diagram of an audio system 200 that includes a pair of true wireless earbuds communicating with an audio source. Audio system 200 can include earbuds 110 and audio source device 120.

Referring to earbuds 110, components of earbud 110-1 can include: antenna 210; wireless communication interface 220; processing system 230; microphone 240; and speaker 250. Earbud 110-2 may have the same components. Antenna 210 can be used for receiving and transmitting Bluetooth-family communications, including basic rate/extended data rate (BR/EDR), and LE (including LE Audio which uses LE). Wireless communication interface 220 can be implemented as a system on a chip (SOC). Wireless communication interface 220 can include a Bluetooth radio and componentry necessary to convert raw incoming data (e.g., audio data, other data) to Bluetooth packets for transmission via antenna 210. A single radio may be present on each of earbuds 110, thus requiring transmissions, even on different frequencies, to occur at different times. Wireless communication interface 220 may also include componentry to enable one or more alternative or additional forms of wireless communication, both with an audio source and between earbuds. Processing system 230 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored locally using one or more non-transitory processor-readable mediums, such as random-access memory (RAM), and/or flash memory. In some embodiments, processing system 230 and wireless communication interface 220 may be part of a same circuit or SOC.

In some earbuds, microphone 240 may be present. In some embodiments, each of earbuds 110 has a microphone. In other embodiments, only one of earbuds 110 has a microphone. In still other embodiments, no microphone may be present in either of earbuds 110. Audio captured using the one or more microphones of earbuds 110 can be transmitted to audio source device 120. This audio, which can be referred to as “upstream” audio, may include voice, such as for use in a telephone call, video conference, gaming, etc. Various componentry (not illustrated) may be present between wireless communication interface 220, processing system 230, and microphone 240, such as an analog to digital converter (ADC) and an amplifier.

Speaker 250 converts received analog signals to audio. Various componentry (not illustrated) may be present between wireless communication interface 220, processing system 230, and speaker 250, such as a digital to analog converter (DAC) and an amplifier.

Various components of earbud 110-1 are not illustrated. In addition to the ADC, DAC, and amplifiers previously mentioned, earbud 110-1 also includes a power storage component, such as one or more batteries, and associated componentry to allow for recharging of the power storage component. Also present is a housing and componentry to hold earbud 110-1 within a user's ear. One or more non-transitory processor readable mediums can be understood as present and accessible by wireless communication interface 125, processing system 230, or both. For instance, such mediums may be used for temporary storage of data (e.g., buffers) and storing data necessary for Bluetooth communication (e.g., encryption keys).

Audio source device 120 can include: antenna 260; wireless communication interface 125; processing system 280; and data storage 290. Antenna 260 can be used for receiving and transmitting Bluetooth-family communications, including BR/EDR, and LE. Wireless communication interface 125 can be implemented as a system on a chip (SOC). Wireless communication interface 125 can include a Bluetooth radio and componentry necessary to convert raw incoming data (e.g., audio data, other data) to Bluetooth packets for transmission via antenna 260. Wireless communication interface 125 can additionally or alternatively be used for one or more other forms of wireless communications. Processing system 280 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored locally using one or more non-transitory processor-readable mediums via data storage 290, which can include random access memory (RAM), flash memory, a hard disk drive (HDD) and/or a solid-state drive (SSD). In some embodiments, processing system 280 and wireless communication interface 125 may be part of a same circuit or SOC.

Audio source device 120 can include various other components. For example, if audio source device 120 is a smartphone, various components such as: one or more cameras, a display screen or touch screen, volume control buttons, or other wireless communication interfaces can be present.

FIG. 3 illustrates an embodiment of an audio system 300 in which true wireless earbuds communicate with each other in addition to communicating with an audio source. Earbud 110-1 can perform wireless communications using cross-link 310 with earbud 110-2 and, similarly, earbud 110-2 can perform wireless communications using cross-link 311 with earbud 110-1. This communication may occur via a proprietary link specific to earbuds 110 and therefore can be outside of any Bluetooth family protocol specification; alternatively, a Bluetooth-family communication protocol can be used. The path between earbuds 110, when in use by user 301, is predictable because the distance and the object through which the signals pass (the head of user 301) remain constant. This path can be expected to produce insufficient attenuation to negatively impact communication between earbuds. The path, however, from audio source device 120 to the earbuds is harder to predict since the position of audio source device 120 relative to earbuds 110 can vary substantially and can result in significantly different attenuation at one earbud compared to the other, such as due to cross-body attenuation.

Cross-links 310 and 311 can use Bluetooth LE 2M, LE HDT (pending standardization), LE proprietary high data rate modes, classic BR/EDR, or some proprietary communication scheme. Therefore, while Bluetooth-compliant wireless communications occur between earbuds 110 and audio source device 120, communications directly between earbuds do not necessarily need to be compliant with Bluetooth or any other particular communication protocol.

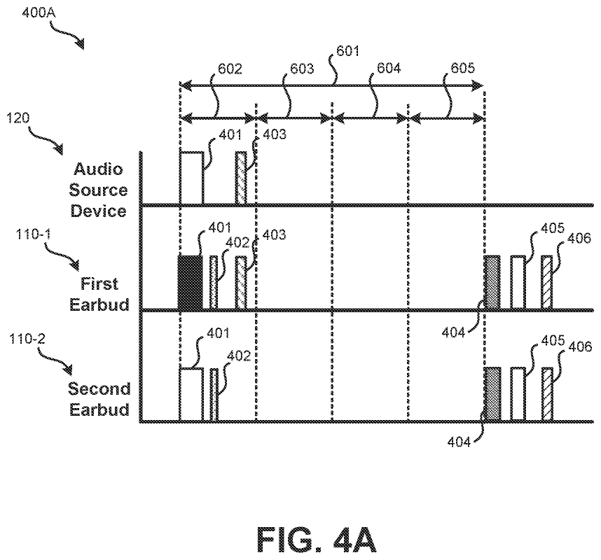

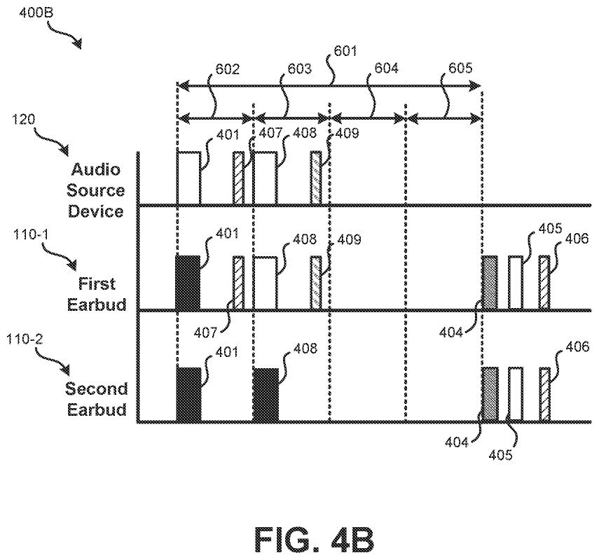

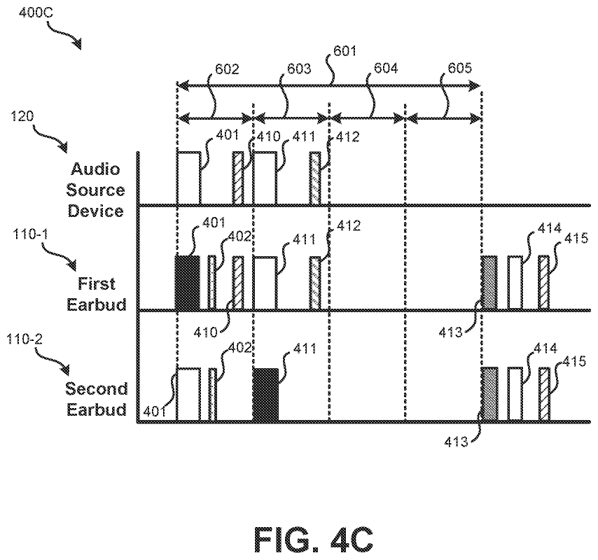

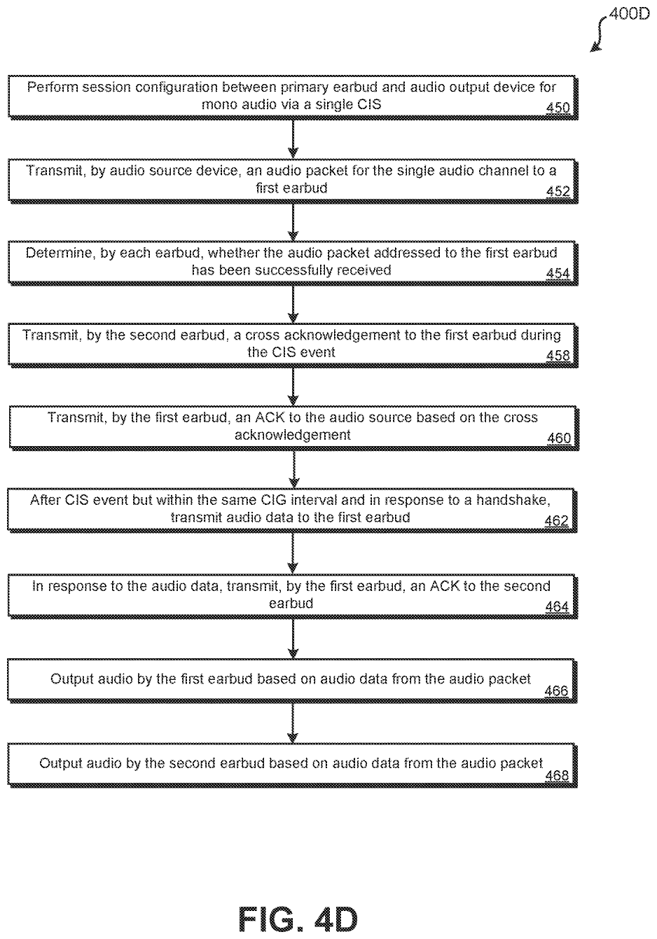

In some embodiments, communication between earbuds 110 can be in the form of a cross-acknowledgement, referred to as a CrossACK for short. As detailed herein, “cross-” communications refer to wireless communications transmitted directly from a first earbud and received by a second earbud. A CrossACK can allow one of earbuds 110 to notify the other earbud of earbuds 110 that a Bluetooth packet was properly received from a source device. A CrossACK and data packets between earbuds can be sent using the same radio used for Bluetooth communications. The embodiments of FIGS. 4A-4D use CrossACK messages transmitted directly between earbuds. These short messages allow for one earbud to inform the other earbud that audio data has been properly received. Therefore, the use of CrossACK messages can be used to decrease the number of retransmissions requested from an audio source and increase the likelihood that each packet is properly received by each earbud.

FIG. 4A illustrates an embodiment 400A of transmitting mono audio from an audio source to true wireless earbuds using a single CIS event within a CIG interval. In embodiment 400A, crossACKs are used for communication between earbuds 110. Embodiment 400A can be performed using BLE communication between audio source device 120 and earbuds 110 or some other short-range wireless communication protocol used for device-to-device communication. Method 400D of FIG. 4D is described concurrently with embodiment 400A. Method 400D is performed using true wireless earbuds as detailed in relation to FIGS. 1-3 and mono audio. At block 450, at some time prior to the transmission of audio packet 401, a session configuration is performed between the audio output device and the primary earbud of earbuds 110. During this session configuration, interface 125 provides data to earbuds 110 indicating that a single audio stream (i.e., mono audio) is to be output, the form of a single CIS to the primary earbud. An ACL may already be established between at least the primary earbud and the audio output device. Earbuds 110 can exchange information with each other such that the secondary earbud can successfully receive packets addressed exclusively for the primary earbud on the single CIS. This exchanged information can include CIS timing information, CIS properties (e.g., physical layer information), encryption keys, etc. Following block 450, earbuds 110 are prepared to receive and output the mono audio via both earbuds. The remainder of method 400 is performed based on a single audio channel, mono audio, having been configured during block 450. In the embodiments of FIGS. 4A-7D, audio packets are addressed to only first earbud 110-1 (which is functioning as the primary earbud), with second earbud 110-2 (which is functioning as the secondary earbud) using the exchanged information to “sniff” the audio packets addressed to the primary earbud.

Audio source device 120 can transmit audio packet 401 at block 452 via the CIS. Audio packet 401 is addressed to only first earbud 110-1. From the perspective of audio source device 120, audio source device 120 is communicating with only first earbud 110-1. Accordingly, within a CIG interval, only a single audio CIS event 601 occurs for earbuds 110.

In the example illustrated, first earbud 110-1 determines it has failed to properly receive audio packet 401 at block 454. However, second earbud 110-2 determines it has successfully sniffed audio packet 401, which is addressed to only earbud 110-1, at block 454. In response, second earbud 110-2 transmits CrossACK 402 to first earbud 110-1 at block 458. CrossACK 402 indicates to first earbud 110-1 that the audio packet has been successfully received by second earbud 110-2. CrossACK 402 is transmitted after audio packet 401, but before first earbud 110-1 responds to audio source device 120 with either an ACK or a NAK.

While first earbud 110-1 did not properly receive audio packet 401, because it did receive CrossACK 402, first earbud 110-1 send ACK 403 to audio source device 120 at block 460. In response to ACK 403, audio source device 120 does not retransmit the audio data of audio packet 401. Therefore, following subevent 602, second earbud 110-2 has received audio data for the mono audio channel while first earbud 110-1 has not successfully received any audio data during CIS event 601.

In some embodiments, the remaining subevents within CIS event 601 remain empty due to ACK 403 being received by audio source device 120. After CIS event 601 and within a same CIG interval, communication can occur between first earbud 110-1 and second earbud 110-2. In a handshake arrangement, on a communication link between earbuds 110, one earbud would be a central device and the other earbud would be a peripheral device. Which devices serve as the central device can be independent of which device is functioning as the primary earbud. The central device initiates communication on the cross-link between earbuds and the peripheral can then respond to that communication. In this arrangement, the peripheral cannot initiate communication with the central earbud. In such arrangements, whichever earbud is serving as the peripheral must be queried by the central earbud to determine whether the peripheral earbud requires its audio data. Therefore, if second earbud 110-2 is in the peripheral role, first earbud 110-1 initiates the communication and queries second earbud 110-2 as part of the handshake process. Alternatively, if second earbud 110-2 is in the central device role, second earbud 110-2 would initiate the communication and query first earbud 110-1 as part of the handshake process.

In the illustrated embodiment, first earbud 110-1 is functioning as the central earbud and second earbud 110-2 is functioning as the peripheral. As such, first earbud 110-1 sends request message 404 to second earbud 110-2 within the CIG interval of CIS event 601. In response to the request, second earbud 110-2 transmits audio data as audio packet 405 from audio packet 401 to first earbud 110-1 at block 462. In some embodiments, in response to receiving audio packet 405, earbud 110-1 transmits ACK as packet 406 to second earbud 110-2 at block 464. If ACK transmitted as packet 406 is not received by earbud 110-2, at least one additional attempt at transmitting the audio data to first earbud 110-1 may be attempted.

If, instead of failing to receive packet 401 in subevent 602, first earbud 110-1 had successfully received packet 401, based on CrossACK 402, first earbud 110-1 would have information indicating that second earbud 110-2 has also successfully received packet 401. As such, no data would need to be exchanged between earbuds after the CrossACK for packet 401.

In an alternative embodiment, data may be relayed between earbuds 110 during CIS event 601. Since an ACK was transmitted in subevent 602, earbuds 110 can expect no communications with audio source device 120 during subevents 603, 604, and 605. Instead, the earbuds may perform communication between each other during one or more of these unused subevents. For example, in some embodiments, an ACK is always transmitted by first earbud 110-1 to audio source device 120 by at least subevent 604 such that the time of subevent 605 is kept available for cross-communication among earbuds 110. In another embodiment, an ACK is always transmitted by first earbud 110-1 to audio source device 120 by at least subevent 603 such that the time of subevent 604 and subevent 605 is kept available for cross-communication among earbuds 110.

At block 466 first earbud 110-1 outputs audio via its speaker based on the audio data received from the second earbud for the mono audio. At block 468, second earbud 110-2 outputs the same audio via its speaker based on the audio data for the mono audio. Variations on method 400D, such as in accordance with FIGS. 4B and 4C, can be performed based on whether and which earbud(s) successfully received an audio packet.

FIG. 4B illustrates an embodiment 400B of transmitting mono audio between an audio source and earbuds using a single CIS within a CIG interval in which a cross acknowledgement is not received by the primary earbud from the secondary earbud. As detailed in relation to block 450, a session configuration is performed, which is indicative of only a single CIS to be used for mono audio, and earbuds 110 can exchange information in order for the secondary earbud to be able to successfully receive packets addressed exclusively for the primary earbud on a CIS.

Audio source device 120 can transmit audio packet 401. Audio packet 401 is transmitted on the single CIS and is addressed only to first earbud 110-1. From the perspective of audio source device 120, audio source device 120 is sending the mono audio channel to only first earbud 110-1, which is functioning as the primary earbud. Accordingly, within a CIG interval, only a single audio CIS event 601 occurs for earbuds 110.

In the example illustrated, first earbud 110-1 and second earbud 110-2 fail to properly receive audio packet 401. As such, no CrossACK is transmitted from second earbud 110-2 to first earbud 110-1.

Since first earbud 110-1 did not properly receive audio packet 401 and because it did not receive CrossACK 402, first earbud 110-1 sends NAK 407 to audio source device 120. In response to NAK 407, audio source device 120 retransmits the audio data of audio packet 401 as audio packet 408 in subevent 603. In subevent 603, first earbud 110-1 properly receives audio packet 408 and, as such, transmits ACK 409, which prevents audio source device 120 from sending any additional retransmissions.

In the illustrated embodiment, first earbud 110-1 is functioning as the central earbud and second earbud 110-2 is functioning as the peripheral. As such, first earbud 110-1 sends message packet 404 to second earbud 110-2 within the CIG interval corresponding to CIS event 601. Since a CrossACK was not received by first earbud 110-1 from second earbud 110-2, message packet 404 can include the audio data from audio packet 401 corresponding to the mono audio channel that is also to be output by second earbud 110-2. In response, second earbud 110-2 may transmit an ACK as packet 405.

In a variation, packet 404 can act as a query as to whether second earbud 110-2 needs the audio data from audio packet 401. In response, packet 405 can indicate whether the audio data is needed. If indicated as needed, first earbud 110-1 can transmit packet 406 that includes audio data from audio packet 401.

As detailed in relation to FIG. 4A, in a variation on embodiment 400B, one or more subevents may be reserved within CIS event 601 to allow for communication between earbuds without requiring the use of airtime within the CIG interval outside of CIS event 601.

In some embodiments, even if a CrossACK is received from the secondary earbud, the primary earbud may send up to a predefined number of NAKs in an attempt to receive an audio packet directly from the audio source, rather than needing the audio data to be relayed from the second earbud. FIG. 4C illustrates another embodiment 400C of communications between an audio source and earbuds using a single CIS event within a CIG interval. As detailed in relation to block 450, a session configuration is performed, which is indicative of only a single CIS to be used for mono audio, and earbuds 110 can exchange information in order for the secondary earbud to be able to successfully receive packets addressed exclusively for the primary earbud on a CIS.

Audio source device 120 can transmit audio packet 401. Audio packet 401 is addressed only to first earbud 110-1. From the perspective of audio source device 120, audio source device 120 is sending the mono audio channel to only first earbud 110-1. Accordingly, within a CIG interval, only a single audio CIS event 601 occurs for earbuds 110.

In the example illustrated, first earbud 110-1 fails to properly receive audio packet 401 at block 454. However, second earbud 110-2 is able to successfully sniff audio packet 401, which is addressed to only earbud 110-1. In response, second earbud 110-2 transmits CrossACK 402 to first earbud 110-1. CrossACK 402 indicates that the audio packet has been successfully received. CrossACK 402 is transmitted after audio packet 401, but before first earbud 110-1 needs to respond to audio source device 120 with either an ACK or a NAK.

Despite receiving CrossACK 402, in these embodiments, first earbud 110-1 sends NAK 410 to audio source device 120. Rather than requesting the missed audio data from earbud 110-2, first earbud 110-1 responds with NAK 410 to cause audio source device 120 to retransmit the audio data of audio packet 401. In response to NAK 410, audio source device 120 does retransmit the audio data of audio packet 401 as audio packet 411.

In the illustrated embodiment, earbud 110-1 successfully receives audio packet 411. As illustrated, earbud 110-2 did not properly receive audio packet 411, but this is inconsequential since earbud 110-2 already properly received audio packet 401. (In some embodiments, earbud 110-2 may not attempt to receive audio packet 411 since audio packet 401 was properly received within CIS event 601.) ACK 412 is transmitted to audio source device 120 in response to earbud 110-1 properly receiving audio packet 411. Since both earbuds properly received the audio packet, no relay of audio data between earbuds 110 is needed for CIS event 601.

However, in an alternate arrangement, earbud 110-1 may fail some additional number of times to receive the audio data of audio packet 401. Despite CrossACK 402 having been received, earbud 110-1 may transmit up to a predefined number of NAKs within CIS event 601 or spanning multiple CIS events before relying on second earbud 110-2 to relay the missed audio data. As an example, earbud 110-1 may transmit at least two NAKs, thus using three subevents (602, 603, and 604) to attempt to receive the audio data directly from audio source device 120. If the audio data fails to be received by earbud 110-1, relay between earbuds may be performed on a separate communication link during a subevent (e.g., subevent 605) or outside of CIS event 601 (but within the CIG interval), such as indicated by packet 413, packet 414, and packet 415.

As previously detailed, on a separate link between earbuds 110, one earbud would be a central device and another would be a peripheral device. For example, earbud 110-1 could request the audio data using packet 413. Earbud 110-2 may respond with audio packet 414. When received, earbud 110-1 may respond with an ACK as packet 415.

It should also be noted that earbuds 110 can function in multiple modes. In a first mode, earbuds 110 may function as detailed in relation to any of the embodiments of FIGS. 4A-4D. In a second mode, earbuds 110 may function in a mode that relies on conventional Bluetooth communication. Earbuds 110 may be able to switch between modes, such as in response to user input or a determination by earbuds 110.

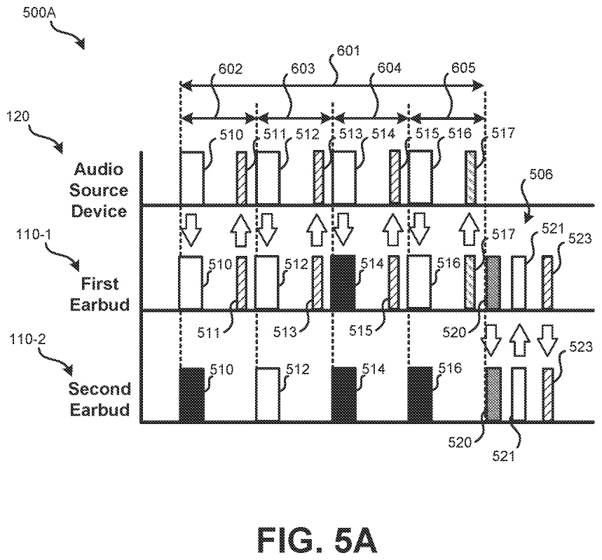

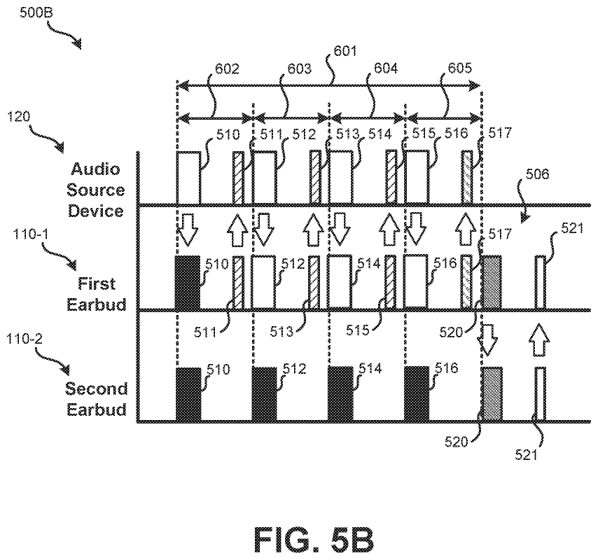

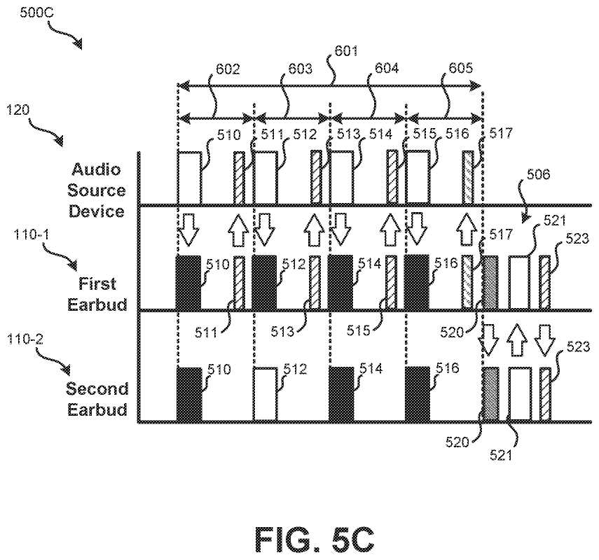

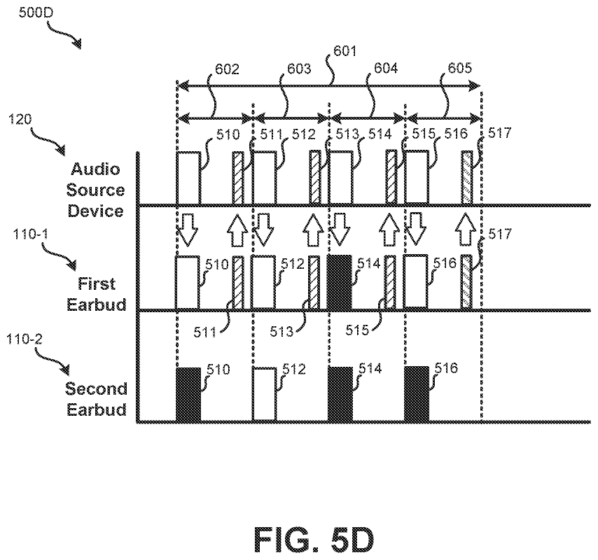

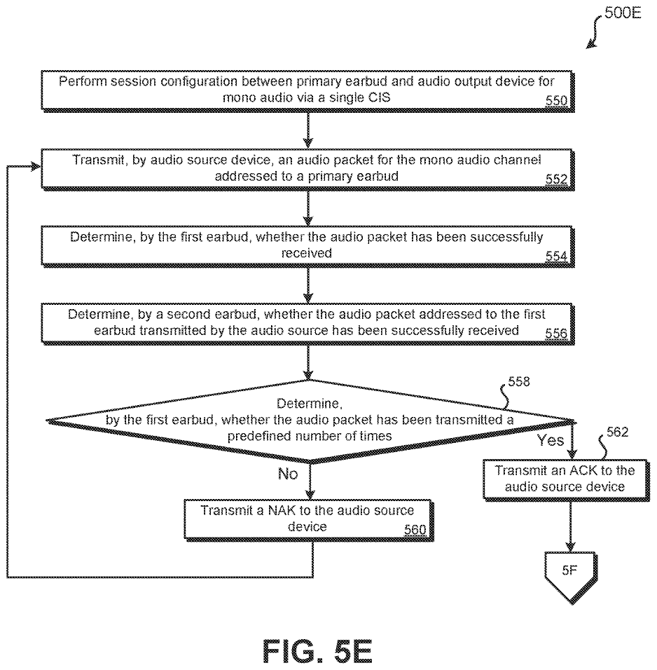

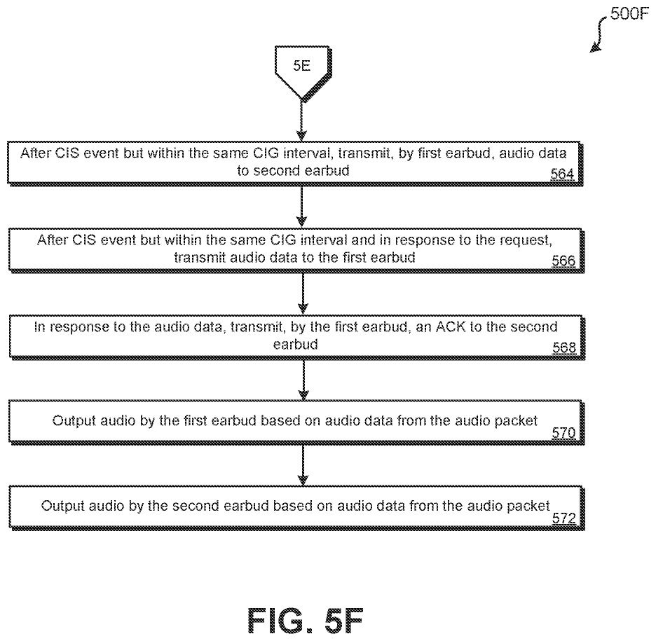

While FIGS. 4A-4D can use a CrossACK for communication between earbuds, however, arrangements are possible in which no CrossACK is used. FIG. 5A illustrates an embodiment 500A of communications between an audio source and true wireless earbuds using a single CIS event within a CIG interval. From the perspective of audio source device 120, audio packets for a mono audio stream are being sent via a wireless communication protocol such as Bluetooth LE to a single audio output device. From the perspective of audio source device 120, the single audio channel is streamed to the primary earbud. Earbuds 110 manage any relay of audio packets needed without involvement of audio source device 120. Method 500E of FIG. 5E is described concurrently with embodiment 500A. Method 500E is performed using true wireless earbuds as detailed in relation to FIGS. 1-3 and a mono audio stream.

In the example of FIG. 5A, first earbud 110-1 is used as the primary or leader earbud. In embodiment 500A, first earbud 110-1 can be the left or the right earbud. In other embodiments, second earbud 110-2 can be the primary or leader earbud. Within a single CIG interval, only a single CIS event 601 occurs in which one or more audio packets for the mono audio channel are transmitted. As illustrated, CIS event 601 includes four subevents: subevent 602, subevent 603, subevent 604, and subevent 605.

At some point prior to CIS event 601 occurring, at block 550, a session configuration is performed between the audio output device and the primary earbud of earbuds 110. During this session configuration, interface 125 provides data to earbuds 110 indicating that a single audio stream (i.e., mono audio) is to be output in the form of a single CIS. The single CIS from the audio source device to the primary earbud can be established. Earbuds 110 can exchange information directly with each other such that the secondary earbud can successfully receive packets addressed exclusively for the primary earbud on the single CIS. This exchanged information can include CIS timing information, CIS properties (e.g., physical layer information), encryption keys, etc. Following block 450, earbuds 110 are prepared to receive and output mono audio via both earbuds. The remainder of method 400 is performed based on a single audio channel, mono audio, having been configured during block 450. In the embodiments of FIGS. 5A-5F, audio packets are addressed to only first earbud 110-1 (which is functioning as the primary earbud), with second earbud 110-2 (which is functioning as the secondary earbud) using the exchanged information to “sniff” the audio packets addressed to the primary earbud.

Audio source device 120 transmits audio packet 510 at the start of subevent 602 at block 552. Audio packet 510 includes audio data for the mono audio channel. In the illustrated example of embodiment 500A, first earbud 110-1 properly receives audio packet 510.

Second earbud 110-2 does not communicate directly with the audio source device 120. However, earbud 110-2 has the encryption credentials of earbud 110-1 and other data necessary to intercept or “sniff”′ communications transmitted by audio source device 120 to earbud 110-1. Therefore, earbud 110-2 may be able to successfully receive audio packet 510 and decrypt the contents despite the audio source only transmitting packet 510 with the intention of it being received by earbud 110-1.

At block 554, earbud 110-1 receives the transmitted packet and determines it has properly received the audio packet transmitted by the audio source device. At block 556, earbud 110-2 attempts to receive and determines whether it has properly received the audio packet transmitted by the audio source device that was addressed to only the earbud 110-1. In the embodiment of FIG. 5A, the audio packet is not properly received. If it was properly received, the audio data would be stored and processed for output.

At block 558, earbud 110-1 determines whether a predefined number of transmissions (or retransmissions) of the audio data has occurred by the audio source. If the predefined number has not been reached, despite properly receiving audio packet 510, earbud 110-1 transmits NAK 511 to audio source device 120 device at block 560. (In some other embodiments, NAK 511 and/or subsequent NAKs are not transmitted. Rather, an implicit NAK is provided to audio source device 120 by not transmitting any response. The lack of response to a transmitted packet can be interpreted as a NAK by audio source device 120.) Earbud 110-1 at this stage does not have data indicating whether earbud 110-2 properly received audio packet 510. Therefore, earbud 110-1 transmits a predefined number of NAKs to increase the likelihood that the audio data of audio packet 510 is received by earbud 110-2.

During subevent 603, in response to NAK 511, audio source device 120 retransmits the same audio data as audio packet 510 as audio packet 512. In the illustrated embodiment, first earbud 110-1 successfully receives audio packet 512 (but the contents can be discarded or ignored since the same audio data was received in audio packet 510). Alternatively, since audio packet 510 was properly received, earbud 110-1 may not attempt to receive audio packet 512 or subsequent packets within CIS event 601. However, in this example, earbud 110-2 is able to successfully sniff audio packet 512. Earbud 110-2 does not inform earbud 110-1 or audio source device 120 within subevent 603. In response to audio packet 512, despite successfully receiving, earbud 110-1 transmits NAK 513. In this embodiment, NAK 513 is transmitted because a predefined number of transmissions (or retransmissions) of the audio data of audio packet 510 has not yet occurred.

During subevent 604, in response to NAK 513, audio source device 120 retransmits the same audio data for the mono audio channel as audio packet 510 as audio packet 514. In the illustrated embodiment, first earbud 110-1 fails to successfully receive audio packet 514 (which is immaterial since the same audio data was received in audio packet 510). Here earbud 110-2 also fails to successfully sniff audio packet 514. This is also immaterial since the same audio data was received in audio packet 512. (Since audio packet 512 was properly received by second earbud 110-2, future transmissions of the same audio data within CIS event 601 may be ignored by second earbud 110-2 without an attempt being made to receive the data.) In response to audio packet 514, despite already having properly received the audio data in audio packet 510, earbud 110-1 transmits NAK 515. In this embodiment, NAK 515 is transmitted because a predefined number of transmissions (or retransmissions) of the audio data of audio packet 510 has not yet occurred.

During subevent 605, in response to NAK 515, audio source device 120 retransmits the same audio data as audio packet 510 as audio packet 516. In the illustrated embodiment, first earbud 110-1 successfully receives audio packet 516, which is immaterial since the same audio data was received in audio packet 510. Here earbud 110-2 fails to successfully sniff audio packet 516. This failed reception is immaterial since the same audio data was received in audio packet 512. In embodiment 500A, the predefined number of retransmissions is three (or the predefined number of total transmissions is four, which happens to be the same number of subevents in CIS event 601). Therefore, following block 558, earbud 110-1 transmits ACK 517 at block 562. In another situation, if earbud 110-1 had not properly received packet 516, ACK 517 would still be transmitted because the audio data was previously properly received and the maximum number of transmissions has been reached. In response to ACK 517, audio source device 120 does not reattempt any further transmissions of the audio data in a future CIS event during the next CIG interval.

Following CIS event 601, both earbuds have properly received the audio data of audio packet 510. Each earbud decrypts the received audio packet and extracts the audio data corresponding to the mono audio channel. The audio data corresponding to the mono audio channel can be buffered, then output via each of the earbud's speaker.

At the conclusion of subevent 605, each earbud of earbuds 110 does not have information indicating whether the other earbud successfully received the audio data for the mono audio channel. Following CIS event 601 within the CIG interval, earbuds 110 have the opportunity to exchange audio data via cross communications 506 occurring with the same CIG interval as CIS event 601. This exchange may only occur if needed or, in some embodiments, may always be performed.

In a first set of embodiments, communication links may be present between first earbud 110-1 and second earbud 110-2 in each direction. This link may be some other form than a CIS used for transmitting audio data from audio source device 120 to earbuds 110, such as an ACL link. On a respective link, if audio data is needed (e.g., all four attempts at reception failed in embodiment 500A for a particular earbud), the earbud could transmit a request within the CIG interval after completion of the single CIS event directly to the other earbud. In response to this request, the other earbud may transmit a packet that includes the audio data, which may include only the audio for the audio channel needed by the requesting earbud. In response to receiving the packet, an ACK may be transmitted.

In another set of embodiments, as illustrated in FIG. 5A and detailed in method 500E, only a single communication link (e.g., Bluetooth LE link) is present between earbud 110-1 and earbud 110-2. After completion of CIS event 601, earbud 110-1 may transmit packet 520 including the audio data for the mono audio channel to second earbud 110-2 at block 564. If available, the audio data for the mono audio channel is transmitted because first earbud 110-1 does not have information indicating whether or not second earbud 110-2 requires the audio data from audio packet 510. Alternatively, a handshake between earbuds 110 can be performed before sending the audio data. The handshake is used by earbud 110-1 to determine if second earbud 110-2 needs the audio data or not. If the second earbud 110-2 needs the audio data for the mono audio channel, then the audio data is transmitted by first earbud 110-1. If second earbud 110-2 does not need the audio data, then the audio data is not transmitted by first earbud 110-1. This arrangement can be more energy efficient compared with embodiments in which the audio data is sent blindly.

Alternatively, as part of the handshaking process, earbud 110-1 may request the audio data of audio packet 510 from earbud 110-2, which would occur if first earbud 110-1 did not properly receive any of packets 510, 512, 514, and 516. If packet 520, which could be part of the handshaking process, included a request, packet 521 includes the audio data for the mono audio channel received during the CIG interval, which can occur at block 566. If packet 520 did not include a request, packet 521 may be an ACK to acknowledge proper receipt of packet 520. (If a NAK is transmitted instead, the audio data of packet 520 may be triggered to be retransmitted within the CIG interval.) If packet 521 included audio data, ACK 523 may be transmitted at block 568. (If a NAK is transmitted instead, the audio data of packet 521 may be triggered to be retransmitted within the CIG interval.) Using the audio from the single CIS, both earbuds output the mono audio channel. At block 570, earbud 110-1 outputs audio via the speaker based on the audio data and at block 572, earbud 110-2 outputs audio based on the audio data from the audio packet via its speaker.

FIG. 5B illustrates an embodiment 500B of communications between an audio source and true wireless earbuds using a single CIS event for a mono audio stream within a CIG interval, as in FIG. 5A. In embodiment 500B, second earbud 110-2 fails to receive each transmission of the audio data of audio packet 510. From the perspective of audio source device 120, audio packets are being sent via a protocol, such as Bluetooth LE, to a single audio output device. As detailed in relation to FIG. 5A, within a CIG interval, a single CIS event is used to transmit the audio data for the mono audio channel that will be output via both earbuds 110. Again here, earbud 110-1 is functioning as the leader earbud and earbud 110-2 is functioning as the hidden earbud.

Embodiment 500B proceeds generally in accordance with embodiment 500A. In this example, both earbuds 110 failed to receive audio packet 510. In response, earbud 110-1 sends NAK 511 (which would have been a NAK even if audio packet 510 was properly received).

A key difference to embodiment 500B is that second earbud 110-2 failed to receive each transmission of the audio data of audio packet 510. Therefore, following CIS event 601, second earbud 110-2 has not received the audio data, but earbud 110-1 has received the audio data for the mono audio channel.

Following CIS event 601 and within the same CIG interval, a handshaking process can be performed in order to determine whether audio data should be transmitted to second earbud 110-2 by first earbud 110-1. Following handshaking, since earbud 110-2 needs the audio data for the mono audio channel, earbud 110-1 sends the audio data for the mono audio channel in packet 520 within the same CIG interval following CIS interval 501 using a separate Bluetooth LE communication link between earbuds 110 (or via a proprietary link). If audio packet 520 is properly received by earbud 110-2, packet 521, which is an ACK, is transmitted. In this example, packet 520 would not include a request for audio data for the audio channel of earbud 110-1 because at least one packet was properly received within CIS event 601 by earbud 110-1.

In an alternate embodiment, following CIS event 601 and within the CIG interval, second earbud 110-2 may transmit a request packet to earbud 110-1. In response, earbud 110-1 can transmit the audio data to earbud 110-2 in a packet. In response to properly receiving, an ACK may be transmitted back to earbud 110-1. (If a NAK was transmitted instead, at least one retransmission within the CIG interval may be attempted.)

More specifically, in the handshake arrangements detailed herein, on the link between earbuds 110, one bud would be a central device and another would be a peripheral device. The central device initiates communication on the link and the peripheral can then follow up on that communication. In this arrangement, the peripheral cannot initiate communication. In such arrangements, whichever earbud is serving as the peripheral must be queried by the other earbud to determine whether the peripheral earbud requires its audio data. Therefore, if second earbud 110-2 is in the peripheral role, first earbud 110-1 would have to initiate the communication and then query second earbud 110-2 as part of the handshake process. Alternatively, if second earbud 110-2 is in the central device role, second earbud 110-2 would initiate the communication and query first earbud 110-1 as part of the handshake process.

FIG. 5C illustrates an embodiment 500C of communications between an audio source and true wireless earbuds using a single CIS event for mono audio within a CIG interval, as in FIG. 5A. In embodiment 500C, second earbud 110-2 properly receives a transmission of the audio data of audio packet 510, but earbud 110-1 fails to receive every transmission during CIS event 601. From the perspective of audio source device 120, audio packets are being sent via Bluetooth LE to a single audio output device. As detailed in relation to FIG. 5A, within a CIG interval, a single CIS event is used to transmit audio data for the mono audio channel. Again in this embodiment, earbud 110-1 is functioning as the leader earbud and earbud 110-2 is functioning as the hidden earbud.

Embodiment 500C proceeds generally in accordance with embodiment 500A. In this example, both earbuds 110 failed to receive audio packet 510. In response, earbud 110-1 sends NAK 511 (which would have been a NAK even if audio packet 510 was properly received).

A key difference to embodiment 500C is that first earbud 110-1 failed to receive each transmission of the audio data of audio packet 510. Therefore, following CIS event 601, first earbud 110-1 has not received the audio data, but earbud 110-2 has received the audio data for the mono audio channel in successfully received audio packet 512.

Following CIS event 601 and within the same CIG interval, earbud 110-1 sends request packet 520 for the audio data using a separate Bluetooth LE communication link between earbuds 110 (or via a proprietary link). In response, second earbud 110-2 transmits audio packet 521 which includes the audio data for the mono audio channel. Following successful receipt, ACK 523 can be transmitted to earbud 110-2. (If a NAK was transmitted instead, at least one retransmission within the CIG interval may be attempted.)

Continuing to refer to embodiment 500C, in an alternative embodiment, ACK 517 may be a NAK in response to earbud 110-1 failing to receive all packets during CIS event 601. If a maximum number of retries, as stored by audio source device 120, has not yet been reached, audio source device 120 may retransmit the audio data of audio packet 510 during a next CIS event in the next CIG interval. In response, whether received properly or not, earbud 110-1 may transmit an ACK because the audio data was successfully retrieved from earbud 110-2. If the audio data was not properly retrieved from second earbud 110-2, earbud 110-1 may send NAKs until the audio data is properly received or audio source device 120 reaches a maximum number of retries and transitions to transmitting a next audio packet.

In a variation on the embodiments presented in relation to FIGS. 5A-5C, in some embodiments, an airtime bandwidth optimization can be performed by earbuds 110. An airtime bandwidth optimization allows for earbuds 110 to adjust to link conditions between earbuds 110 and audio source device 120 and also to link conditions between earbud 110-1 and earbud 110-2. In general, first earbud 110-1, serving as the primary earbud, can determine that the link quality between earbuds 110 is relatively poor but the link quality between at least earbud 110-2 and audio source device 120 is relatively good. First earbud 110-1 may increase the number of NAKs transmitted to audio source device 120 despite first earbud 110-1 having properly received an audio packet. This arrangement may be beneficial because second earbud 110-2 is more likely to successfully receive an audio packet transmitted by audio source device 120 than audio data relayed by earbud 110-1.

As another possible scenario, if first earbud 110-1 determines that the link quality between earbuds 110 is relatively good, but the link quality between earbud 110-1 or earbud 110-2 and audio source device 120 is relatively bad, first earbud 110-1 may decrease a number of NAKs transmitted to audio source device 120 when first earbud 110-1 has properly received an audio packet or may immediately transmit an ACK when the audio packet is successfully received by first earbud 110-1. This arrangement may be beneficial because the earbuds are more likely to successfully receive audio data relayed by the other earbud than audio source device 120.

These airtime bandwidth optimizations can help decrease the total number of retransmissions of audio data, thus saving airtime and, possibly, battery power (e.g., of audio source device 120 and/or of earbuds 110). In order to assess link quality, a measured signal strength may be used, such as for comparison to a stored signal strength (e.g., a value for the cross-earbud link, a second value for the link from audio source device 120 to earbuds 110).

Alternatively, the number of times that first earbud 110-1 needs to relay audio to second earbud 110-2, the number of times that second earbud 110-2 needs to relay audio to first earbud 110-1, and the number of missed packets from audio source device 120 by each earbud may be tracked over a rolling window of time to determine whether the link between audio source device 120 and each of earbuds 110 is stronger or weaker relative to the link between earbuds. These values can then be compared (e.g., to each other, to stored threshold values) to determine the adaptive scheme that should be used to optimize bandwidth.

In alternate embodiments, no communication is performed directly between earbuds to exchange audio data. Rather, each earbud is reliant on receiving the audio directly from audio source device 120. FIG. 5D illustrates an embodiment 500D of communications between an audio source and true wireless earbuds using a single CIS event within a CIG interval for mono audio. From the perspective of audio source device 120, audio packets are being sent via Bluetooth LE to a single audio output device. As detailed in relation to FIG. 5A, within a CIG interval, a single CIS event is used to transmit audio data for the mono audio channel.

Embodiment 500D proceeds as detailed in relation to embodiment 500A except there is no cross-earbud communication following completion of CIS event 601. Therefore, each earbud relies on receiving the audio data for the mono audio channel directly from audio source device 120. The number of NAKs transmitted by the primary earbud can be varied to optimize bandwidth usage based on link quality between earbuds 110 and audio source device 120. Such an arrangement may be particularly beneficial for low-latency applications, such as video conferencing, gaming, audio conferencing, and phone calls. Further, the arrangement of embodiment 500D reserves more airtime within the CIG interval for other Bluetooth communications.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for using a short-range wireless communication link, the method comprising:
performing a session configuration between a pair of true wireless earbuds and an audio source device in which a single connected isochronous stream (CIS) is established to transmit a monophonic audio stream from the audio source device to the pair of true wireless earbuds, wherein
the pair of true wireless earbuds comprising a primary earbud and a secondary earbud;
after performing the session configuration, receiving, by the primary earbud, an audio packet transmitted on the single CIS addressed to only the primary earbud;
determining, by the primary earbud, that the audio packet was successfully received by the primary earbud;
determining, by the primary earbud, that data of the audio packet has not yet been transmitted a predefined number of times; and
despite determining that the audio packet was successfully received by the primary earbud, transmitting a negative acknowledgement to the audio source device in response to determining that data of the audio packet has not yet been transmitted a predefined number of times.

2. The method for using the short-range wireless communication link of claim 1, further comprising:
determining, by the secondary earbud, that the audio packet has not been successfully received.

3. The method for using the short-range wireless communication link of claim 2, further comprising:
receiving, by the secondary earbud, a second audio packet transmitted on the single CIS, where the second audio packet comprises same audio data as the audio packet; and
determining, by the secondary earbud, that the second audio packet has been successfully received.

4. The method for using the short-range wireless communication link of claim 2, further comprising:
during a connected isochronous group (CIG) interval in which the audio packet was received by the primary earbud, transmitting, by the primary earbud, audio data from the audio packet to the secondary earbud; and
receiving, by the secondary earbud, the audio data from the primary earbud.

5. The method for using the short-range wireless communication link of claim 1, further comprising:
receiving, by the primary earbud, a second audio packet transmitted on the single CIS, where the second audio packet comprises same audio data as the audio packet;
determining, by the primary earbud, that data of the second audio packet has been transmitted the predefined number of times; and
transmitting an acknowledgement to the audio source device in response to determining that data of the second audio packet has been transmitted the predefined number of times.

6. The method for using the short-range wireless communication link of claim 1, wherein the secondary earbud does not transmit acknowledgements or negative acknowledgements to the audio source device.

7. The method for using the short-range wireless communication link of claim 1, further comprising:
determining, by the primary earbud, a signal strength of a communication link with the secondary earbud; and
adjusting, by the primary earbud, the predefined number based at least in part on the signal strength of the communication link with the secondary earbud.

8. The method for using the short-range wireless communication link of claim 1, wherein the short-range wireless communication link between the primary earbud and the audio source device is a Bluetooth Low Energy (BLE) communication link.

9. The method for using the short-range wireless communication link of claim 1, further comprising:
outputting, by the primary earbud, audio using a first speaker of the primary earbud; and
outputting, by the secondary earbud, audio using a second speaker of the secondary earbud, wherein the audio that is output by the primary earbud and the secondary earbud is the same.

10. The method for using the short-range wireless communication link of claim 1, wherein performing the session configuration comprises receiving and storing, by the secondary earbud, encryption credentials for the primary earbud, and wherein the method further comprises:
receiving, by the secondary earbud, the audio packet transmitted on the single CIS addressed to only the primary earbud; and
decrypting, by the secondary earbud, the audio packet using the encryption credentials.

11. A pair of true wireless earbuds, comprising:
a primary earbud, comprising a first speaker, a first processing system, and a first wireless communication interface; and
a secondary earbud, comprising a second speaker, a second processing system, and a second wireless communication interface, wherein:
the secondary earbud is not physically connected with the primary earbud and the primary earbud is configured to:
perform a session configuration with an audio source device in which a single connected isochronous stream (CIS) is established to transmit a monophonic audio stream from the audio source device to the primary earbud;
after performing the session configuration, receive an audio packet transmitted on the single CIS addressed to only the primary earbud;
determine that the audio packet was successfully received by the primary earbud;
determine that data of the audio packet has not yet been transmitted a predefined number of times; and
despite determining that the audio packet was successfully received by the primary earbud, transmit a negative acknowledgement to the audio source device in response to determining that data of the audio packet has not yet been transmitted a predefined number of times

12. The pair of true wireless earbuds of claim 11, wherein the secondary earbud is configured to determine that the audio packet has not been successfully received.

13. The pair of true wireless earbuds of claim 12, wherein the secondary earbud is further configured to:
receive a second audio packet transmitted on the single CIS, where the second audio packet comprises same audio data as the audio packet; and
determine that the second audio packet has been successfully received.

14. The pair of true wireless earbuds of claim 12, wherein the primary earbud is further configured to:
during a connected isochronous group (CIG) interval in which the audio packet was received by the primary earbud, transmit audio data from the audio packet to the secondary earbud.

15. The pair of true wireless earbuds of claim 11, wherein the primary earbud is further configured to:
receive a second audio packet transmitted on the single CIS, where the second audio packet comprises same audio data as the audio packet;
determine that data of the second audio packet has been transmitted the predefined number of times; and
transmit an acknowledgement to the audio source device in response to determining that data of the second audio packet has been transmitted the predefined number of times.

16. The pair of true wireless earbuds of claim 11, wherein the secondary earbud does not transmit acknowledgements or negative acknowledgements to the audio source device.

17. The pair of true wireless earbuds of claim 11, wherein the primary earbud is further configured to:
determine a signal strength of a communication link with the secondary earbud; and
adjust the predefined number based at least in part on the signal strength of the communication link with the secondary earbud.

18. The pair of true wireless earbuds of claim 11, wherein the short-range wireless communication link between the primary earbud and the audio source device is a Bluetooth Low Energy (BLE) communication link.

19. The pair of true wireless earbuds of claim 11, wherein the primary earbud is configured to output audio using the first speaker; and
the secondary earbud is configured to output audio using the second speaker, wherein the audio that is output by the primary earbud and the secondary earbud is the same.

20. The pair of true wireless earbuds of claim 11, wherein the secondary earbud is further configured to:
receive and store encryption credentials for the primary earbud;
receive the audio packet transmitted on the single CIS addressed to only the primary earbud; and
decrypt the audio packet using the encryption credentials.
